(19) United States
(12) Patent Application Publication
(10) Pub. No.: US 2020/0078968 A1
(43) Pub. Date: Mar. 12, 2020

(54) DISPOSABLE SHAVER SYSTEM AND METHOD

(71) Applicants: Ron Tews, Alpena, MI (US); Patti Tews, Alpena, MI (US)

(72) Inventors: Ron Tews, Alpena, MI (US); Patti Tews, Alpena, MI (US)

(21) Appl. No.: 16/589,047

(22) Filed: Sep. 30, 2019

Related U.S. Application Data
(63) Continuation-in-part of application No. 15/836,585, filed on Dec. 8, 2017, now abandoned.
(60) Provisional application No. 62/443,644, filed on Jan. 6, 2017.

(51) Int. Cl. B26B 21/40; B26B 21/44

(52) U.S. Cl. CPC B26B 21/4012; B26B 21/44

(57) ABSTRACT

A disposable shaver system includes a shaver body having a handle containing a shaving lubricant; a shaver head with an integral blade retainer and at least one cutting blade; a dispensing valve; and a handle closure. The system is configured to provide a compact disposable shaving system allowing a user to shave using the at least one cutting blade and dispense the contents as needed for shaving.

### CROSS-REFERENCE TO RELATED APPLICATION(S)

The present application is a continuation-in-part of U.S. Utility patent application No. 15/836,585, filed on Dec. 8, 2017, pending, which is related to and claims priority to U.S. Provisional patent application No. 62/443,644 filed Jan. 6, 2017—the current application incorporates the entirety of both of these applications by this reference.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of disposable razors of existing art and more specifically relates to a disposable razor with a shaving cream dispenser.

### Related Art

Many individuals use razors. With a conventional disposable hand razor, a razor blade is mounted in a shaving head portion of the hand razor that is carried on an end of a handle, with the handle being grasped by the shaver during shaving. During the shaving operation, the shaver conventionally applies lather-forming shaving lubricant to a body portion, such as the face, to be shaved. The lathers, creams, gels and the like, are applied to the face or body portions, and are typically supplied in large, relatively heavy multiple serving plastic and/or metallic containers. These large containers are suitable for home use.

When traveling it is often desirable to shave before an important meeting or social occasion. It is inconvenient for most individuals to carry a separate shaver and shaving cream dispenser both before and after use. The cans are typically bulky and difficult to store, especially where luggage space is limited. Cans and lotion bottles can leak in the luggage, especially at low pressure in airplane baggage compartments. Thus, it makes little sense to carry the razor, and shaving lubricant can on a short trip. A suitable solution is desired.

U.S. Pat. No. 7,788,809 to Louis D. Tomassetti relates to a disposable razor with integrated shaving cream dispenser. The described disposable razor with integrated shaving cream dispenser includes a disposable safety razor having an integral shaving conditioner dispenser includes a neck to which a blade cartridge is affixed at a top end thereof and a handle extends downwardly therefrom. The handle is ergonomically shaped and has an exterior wall that defines a pressure cavity therein for receiving a shaving conditioning compound and a pressurized dispensing gas. The handle has an opening at its bottom and a valve received in the opening. The valve is configured to dispense the shaving conditioning compound downwardly through the valve with the razor held upright. A dispensing cap covers the valve and is engaged therewith such that movement of the dispensing cap causes release of the shaving conditioning compound downwardly through the valve and out from a discharge opening in the cap while holding the razor upright with the blade cartridge and neck positioned higher than the handle bottom and dispensing cap.

### SUMMARY OF THE INVENTION

A shaving system is disclosed. The disposable shaver system comprises a handle with a hollow tube forming a reservoir, shaving lubricant disposed in the reservoir, and a dispensing valve disposed in or on an end of the hollow tube; a shave head disposed in or on an end of the handle opposite the dispensing valve; and a handle closure disposed to cover the dispensing valve.

Since the system is disposable, it is made in a disposable fashion. For instance, in some embodiments, the handle and handle closure have the minimum thickness achievable while still retaining enough rigidity for use as a razor handle or in capping the system, respectively. In these or other embodiments, the handle and handle closure comprise plastic. In some embodiments, plastic is any one or any combination of polyethylene terephthalate, polypropylene, low-density polyethylene, high density polyethylene, polystyrene, polyvinylchloride, polycarbonate, polylactic acid, polyhydroxyalkonoates, polyurethane, phenolic resin, epoxy resin, silicone, vinyl ester acrylic resin, and urea formaldehyde resins.

The system comes loaded with shaving lubricant and is designed to be thrown away when the lubricant is depleted or before about ten uses. In some embodiments, the shaving lubricant is any one or any combination of shaving creams, lotions, gels, and soaps.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a disposable shaver system, constructed and operative according to the teachings of the present disclosure.

FIG. 1 is a perspective view of the disposable shaver system during an ‘in-use’ condition, according to an embodiment of the disclosure.

FIG. 2 is a side view of the disposable shaver system of FIG. 1, according to an embodiment of the present disclosure.

FIG. 3 is a front view of the disposable shaver system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a disposable razor with a shaving cream dispenser and more particularly to a disposable shaver system as used to improve the means for efficient shaving during travel/home use.

Generally, the present invention provides a means for efficient shaving use on a short trip to the local gym or a longer trip, such as an out of town business trip. It comprises both a razor and a container of shaving lubricant packaged together in one unit and available with different amounts of shaving lubricant in the handle of a disposable razor. Moreover, the device complies with current airline travel restrictions imposed by the Transportation Safety Administration (TSA) which limit the size of containers that can be packed in carry-on luggage. The smaller ounce sizes may be comfortable in the user's hand while shaving. Thus, smaller containers 3.4 ounces or less for shaving creams, lotions and gels are much more desirable for travel and have been increasing in popularity, particularly among frequent travelers. Additionally, not having to search in a travel bag for your razor and can of shaving cream saves time and space in a carry-on bag. The device is disposable and ideal for travel, camping, or any time the user is away from home.

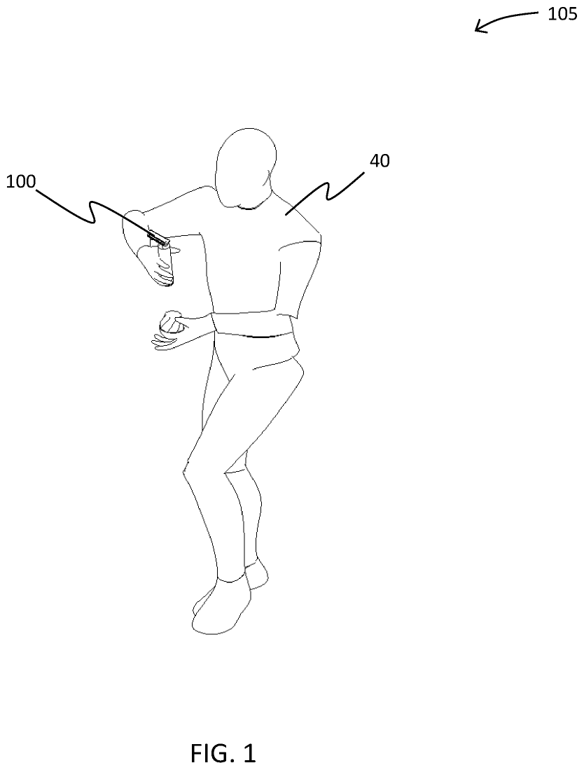

FIGS. 1-3 shows various views of a disposable shaver system 100. A user 40 may use the system 100 having at least one cutting blade 135 and a handle 115 containing shaving lubricant as needed for shaving. The system 100 may also meet federal airline safety regulations. As illustrated, the disposable shaver system 100 may include a body 110, having a handle 115, a shaver head 112 having an integral blade retainer 130 and at least one cutting blade 135. Handle 115 is a hollow tube. A dispensing valve 145 disposed on an end of a handle 115 and a handle closure 150.

As shown in FIG. 1 during an ‘in-use’ condition, a user 40 may use the disposable shaver system 100 by removing the handle closure 150 and by holding the shaver body 110 in one hand and dispensing the shaving lubricant stored in handle 115. The shaving lubricant is any one or any combination of shaving creams, lotions, gels, and soaps. The dispensing valve 145 dispenses the lubricant into the users 40 free hand for application to the skin area. The user 40 may then invert the disposable shaver system 100 and use the shaver head 112, having an integral blade retainer 130 and cutting blade 135, to shave using the at least one cutting blade 135.

Upon completion of shaving, the user 40 may dispose of the disposable shaver system or may choose to replace the handle closure 150 and store it for later use. Although not illustrated, in an embodiment of the disposable shaver system 100, the handle closure 150 may also be configured to provide a standing base for the disposable shaver system 100 such that it may be stored on a flat surface such as for example a vanity or shelf in an upright position to aid in the prevention of contamination of the integral blade retainer 130 and cutting blade 135.

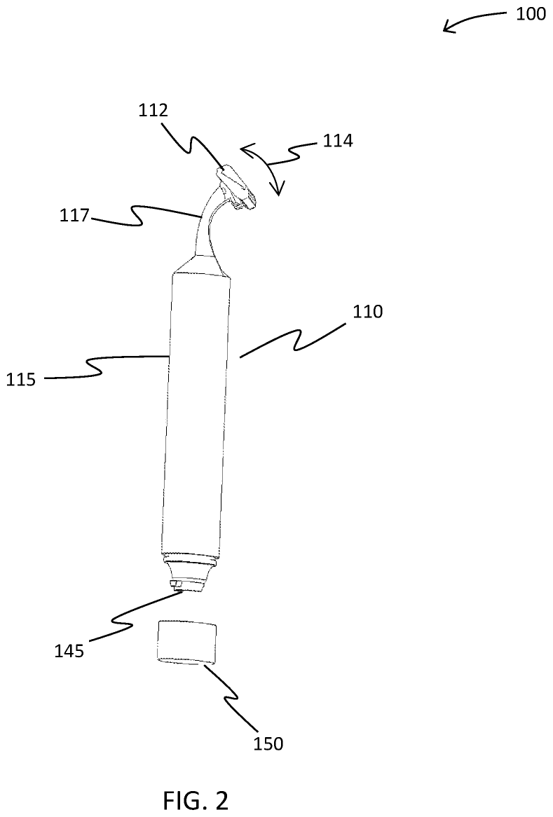

Referring now to FIG. 2 showing the disposable shaver system of FIG. 1, according to an embodiment of the present disclosure. As above, the disposable shaver system 100 may include a shaver body 110, having a hollow handle 115, a shaver head 112 disposed on an end of handle 115. The shaver head 112 has an integral blade retainer 130 and cutting blade 135. A dispensing valve 145 is disposed at an end of the handle 115 opposite shaver head 112 and is capped with a handle closure 150.

Handle 115 may be size to store a volume of up to 3.4 fluid ounces or less of the contents. The handle closure 150 may also provide security to prevent unintended dispensing of contents or contamination when not in-use.

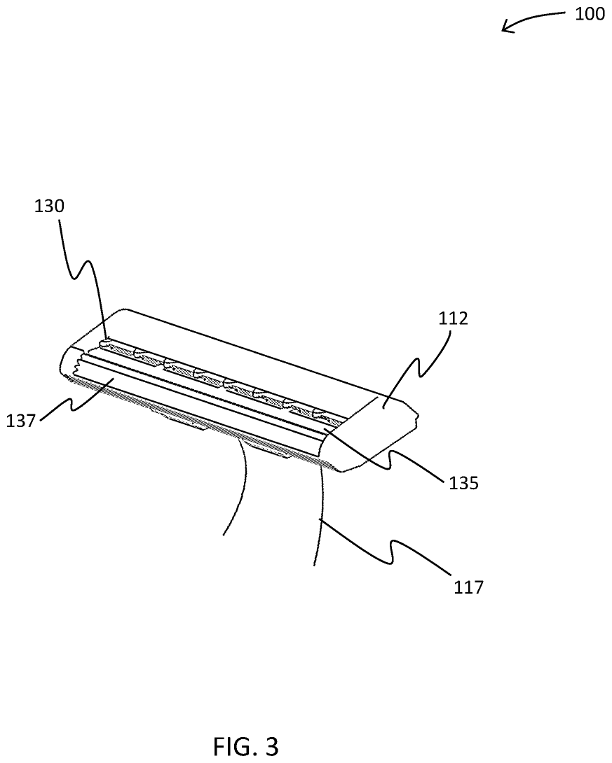

Additionally, the shaver head 112 may be integral to the shaver body 110 and include an integral blade retainer 130. Cutting blade 135 may mount in the integral blade retainer 130 as shown in FIG. 3. In other embodiments, the shaver head 112 may be press fit into handle 115. The shaver head 112 may also include arcuate neck extension 117 fixed to the shaver head 112 connected to handle 115. The disposable shaver system 100 provides a compact disposable shaving system allowing a user 40 to shave using the cutting blade 135 and dispense the contents from handle 115.

FIG. 3 is a top view of the disposable shaver system 100 of FIG. 1, according to an embodiment of the present disclosure. As illustrated here, the shaver head 112 is integral with and fixed to the handle 115 via an arcuate neck extension 117 and further includes an integral blade retainer 130. Cutting blade 135 may mount in the integral blade retainer 130. Other embodiments may include a plurality of cutting blades 135 and the shaver head 112 may pivot as shown in 114. In yet another embodiment, the shaver head 112 may also include a shield, guard, or a lubricating strip 137 adjacent to the cutting blade 135.

For purposes of this disclosure, “disposable” means designed to be discarded after the shaving lubricant is depleted from handle 115 or means designed to be discarded before more than 10, 8, or 5 shaving sessions. As those of ordinary skill in the art will understand, a disposable article is an article that is meant to be thrown away after only several uses and thus is designed so that economics allows for that disposal. Those of ordinary skill in the art will recognize that “disposable” or designed to be discarded means that some aspect of the design of the device has been chosen to allow economical disposal. For instance, the device may be constructed of less-expensive materials or constructed in a less complex way than would be the case if the device were not designed for economical disposal.

Disposable may mean that the device has been economically designed such that at least one feature reduces cost over a non-disposable device.

In some embodiments, the wall thickness of handle 115 is chosen to be an economical thickness. For instance, the thickness may be an acceptable handle wall thickness because the wall thickness falls within the range typically employed by the disposable shaver industry or thinner. In some cases, an acceptable wall thickness of handle 115 is the minimum thickness possible that still retains enough rigidity to use handle 115 as a handle for shaving. In some cases, the wall thickness of handle 115 ranges from 0.025-0.035 inches.

In some embodiments, the wall thickness of the handle closure 150 is chosen to be an economical thickness. For instance, the thickness may be an acceptable handle wall thickness because the wall thickness falls within the range typically employed by the disposable shaver industry or thinner. In some cases, an acceptable wall thickness of the handle closure 150 is the minimum thickness possible that still retains enough rigidity to use the handle closure 150 as a cap. In some cases, the wall thickness of the handle closure 150 ranges from 0.025-0.035 inches.

In some embodiments, the material used for handle 115 or handle closure 150 is chosen to be an economical material. In some embodiments, one or more of the components of the shaving system 100 comprise plastic. In these or other embodiments, a plastic is any one or any combination of polyethylene terephthalate, polypropylene, low-density polyethylene, high density polyethylene, polystyrene, polyvinylchloride, polycarbonate, polylactic acid, polyhydroxyalkonoates, polyurethane, phenolic resin, epoxy resin, silicone, vinyl ester acrylic resin, and urea formaldehyde resins.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A disposable shaver system comprising:
a handle consisting of a hollow tube forming a reservoir, shaving lubricant disposed in the reservoir, and a dispensing valve disposed in or on an end of the hollow tube;
a shave head disposed in or on an end of the handle opposite the dispensing valve;
and
a handle closure disposed to cover the dispensing valve.

2. The system of claim 1 wherein the handle closure has the minimum thickness possible while still retaining enough rigidity for use.

3. The system of claim 2 wherein the handle closure comprises plastic.

4. The system of claim 3 wherein plastic is any one or any combination of polyethylene terephthalate, polypropylene, low-density polyethylene, high density polyethylene, polystyrene, polyvinylchloride, polycarbonate, polylactic acid, polyhydroxyalkonoates, polyurethane, phenolic resin, epoxy resin, silicone, vinyl ester acrylic resin, and urea formaldehyde resins.

5. The system of claim 4 wherein plastic is polystyrene, polypropylene, or polyethylene.

6. The system of claim 5 wherein the shaver is designed to be thrown away when the lubricant is depleted.

7. The system of claim 5 wherein the shaver is designed to be thrown away before ten uses.

8. The system of claim 6 wherein the shaving lubricant is any one or any combination of shaving creams, lotions, gels, and soaps.

9. The system of claim 8 wherein the handle has the minimum thickness possible while still retaining enough rigidity for use.

10. The system of claim 9 wherein the handle comprises plastic.

11. The system of claim 10 wherein plastic is any one or any combination of polyethylene terephthalate, polypropylene, low-density polyethylene, high density polyethylene, polystyrene, polyvinylchloride, polycarbonate, polylactic acid, polyhydroxyalkonoates, polyurethane, phenolic resin, epoxy resin, silicone, vinyl ester acrylic resin, and urea formaldehyde resins.

12. The system of claim 1 wherein the handle is thin-walled.

13. The system of claim 12 wherein the handle has the minimum thickness possible while still retaining enough rigidity for use.

14. The system of claim 13 wherein the handle comprises plastic.

15. The system of claim 14 wherein plastic is any one or any combination of polyethylene terephthalate, polypropylene, low-density polyethylene, high density polyethylene, polystyrene, polyvinylchloride, polycarbonate, polylactic acid, polyhydroxyalkonoates, polyurethane, phenolic resin, epoxy resin, silicone, vinyl ester acrylic resin, and urea formaldehyde resins.

16. The system of claim 15 wherein plastic is polystyrene, polypropylene, or polyethylene.

17. The system of claim 16 wherein the shaver is designed to be thrown away when the lubricant is depleted.

18. The system of claim 16 wherein the shaver is designed to be thrown away before ten uses.

19. The system of claim 18 wherein the shaving lubricant is any one or any combination of shaving creams, lotions, gels, and soaps.
